(19) United States
(12) Patent Application Publication
(10) Pub. No.: US 2005/0002345 A1
(43) Pub. Date: Jan. 6, 2005

(54) Method and system for performing a fast call setup in a wireless telecommunication system

(76) Inventors: Jong-Bum Pyo, Yongin-si (KR); Tae-Won Kim, Yongin-si (KR); Hong-Sung Chang, Suwon-si (KR); Dong-Koon Kong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/834,068

(22) Filed: Apr. 29, 2004

(30) Foreign Application Priority Data
Apr. 30, 2003 (KR) 27636/2003

(51) Int. Cl. H04B 7/216

(52) U.S. Cl. 370/311; 370/342; 455/574

(57) ABSTRACT

A method and system for rapidly processing a call when one of a plurality of user agents (UAs) in a dormant state makes a traffic transmission request in a wireless telecommunication system. The wireless telecommunication system includes an access network (AN) for simultaneously performing group communication with at least two UAs. When no data is generated for a predetermined time after a traffic channel has been set up in an active state, the traffic channel is released and the UA transitions to the dormant state based on a suspended mode. A slot cycle index value is set to a first slot cycle index value for a slot mode operation in the dormant state based on the suspended mode, and the AN is notified of the first slot cycle index value. A paging message is received according to a paging time adjusted by the AN using the first slot cycle index value. The paging message is received, and the traffic channel is set up after the UA transitions to the active state when data to be transmitted is generated in the dormant state based on the suspended mode.

### PRIORITY

This application claims priority under 35 U.S.C. § 119(a) to an application entitled “METHOD AND SYSTEM FOR CARRYING OUT FAST CALL SETUP IN WIRELESS TELECOMMUNICATION SYSTEM”, filed in the Korean Intellectual Property Office on Apr. 30, 2003 and assigned Serial No. 2003-27636, the entire contents of which are incorporated herein by reference.

### BACKGROUND OF THE INVENTION

1. Field of the Invention

The present invention relates to a wireless telecommunication method and system. More particularly, the present invention relates to a method and system for performing fast call setup.

2. Description of the Related Art

A typical mobile communication system can be divided into a system capable of supporting a voice service and a system capable of supporting a data service according to its purpose. An example of the typical mobile communication system is a code division multiple access (CDMA) system. The system supporting only the voice service in the current CDMA system conforms to the International Standard (IS)-95 and protocol based on the IS-95, which is incorporated in its entirety herein by reference. Mobile communication systems are developing into a system capable of supporting high-speed data services. For example, the first generation CDMA 2000 First Evolution (referred to as a “CDMA2000 1×”) is designed to simultaneously support voice services and high-speed data services.

Various demands of users according to the development of the mobile communication system include multimedia information transmission, broadcasting service reception and push-to-talk (PTT) services beyond the simple one-to-one communication in a cellular phone.

When the PTT service is called after a user selects a group of friends, a group of other users, or another user desiring voice communication using information displayed on the UA in a login state, a network capable of providing the PTT service sets up a one-to-one communication path and an inter-group communication path, such that communication can be performed through the established communication path. In particular, the PTT service allows the user to immediately start conversation by simply pressing a PTT button, which is performed differently compared to a conventional phone service. Group communication between three or more joiners can be cost-effectively implemented through the PTT service. For example, communications uses based on the PTT service include working group communication, security communication, communication at a construction site and military communication, among others.

FIG. 1 is a block diagram illustrating a network for providing the PTT service in the CDMA2000 1× system.

Referring to FIG. 1, the PTT service network includes a user agent (UA) 10 for performing wireless access based on the CDMA2000 1× standard and a CDMA2000 1× access network (AN) 20 for performing packet communication with the UA 10 through a radio channel. The PTT service network includes a packet data service node (PDSN) 30 for transmitting, to the AN 20, packet data using, for example, Internet protocol (IP), and a PTT server 50 connected to the PDSN 30 through an IP network 40 for providing the PTT service.

The UA 10 supports the PTT service and is equipped with a PTT button (not shown).

The PTT server 50 manages a PTT session, and relays a voice packet from a talker to a group of listeners.

In the PTT service network, a PTT service protocol can employ a session initiation protocol (SIP) for signalling transmission and a real-time transport protocol (RTP) for real-time voice packet transmission. Here, the SIP is a signalling protocol based on one-to-one communication or a signalling protocol between a server and a client that allows required session information to be exchanged before the beginning of communication or to be removed at the end of communication.

In the conventional wireless communication system, the UA initiates a call of a voice and packet data service, waits in a dormant state if no data is generated, and re-activates a traffic channel if data is generated. When a UA sends a phone call to a neighboring UA, a sound speaker of the neighboring UA starts to emit a ring-tone several seconds after a ring-back tone has been generated. Because a call setup procedure of the conventional wireless communication system as described can cause a communication connection time to be increased, communication cannot be rapidly performed when the PTT service is provided.

### SUMMARY OF THE INVENTION

Therefore, it is an object of the present invention to provide a method and system that can perform a fast call setup in a wireless communication system.

It is another object of the present invention to provide a method and system for performing a fast call setup that can reduce a paging time by dividing a dormant state into a suspended mode and a normal mode.

It is another object of the present invention to provide a method and system for performing a fast call setup that can reduce a paging time of a user agent (UA) in a dormant state when the UA in the dormant state sends a push-to-talk (PTT) service request to a reverse radio link.

It is yet another object of the present invention to provide a method and system for performing a fast call setup that can rapidly re-activate a traffic channel when a user agent (UA) in a dormant state sends a push-to-talk (PTT) service request to a reverse radio link.

In accordance with one aspect of the present invention, the above and other objects can be accomplished by the provision of a method for rapidly processing a call when one of a plurality of user agents (UAs) in a dormant state makes a traffic transmission request in a wireless telecommunication system. The wireless telecommunication system includes an access network (AN) for simultaneously performing group communication with at least two UAs. The method comprises the steps of releasing the traffic channel and transitioning to the dormant state based on a suspended mode when no data is generated for a predetermined time after a traffic channel has been set up in an active state; setting a slot cycle index value to a first slot cycle index value for a slot mode operation in the dormant state based on the suspended mode, and notifying the AN of the first slot cycle index value; receiving a paging message according to a paging time adjusted by the AN using the first slot cycle index value; and receiving the paging message, and setting up the traffic channel after transitioning to the active state when data to be transmitted is generated in the dormant state based on the suspended mode.

In accordance with another aspect of the present invention, the above and other objects can be accomplished by the provisioning of a system for rapidly processing a call when one of a plurality of user agents (UAs) in a dormant state makes a traffic transmission request in a wireless telecommunication system. The wireless telecommunication system includes an access network (AN) for simultaneously performing group communication with at least two UAs. The system comprises the UA for releasing a traffic channel when no data is generated for a predetermined time after the traffic channel has been set up in an active state, transitioning to the dormant state based on a suspended mode, setting a slot cycle index value to a first slot cycle index value for a slot mode operation in the dormant state based on the suspended mode, and re-activating the traffic channel after transitioning to the active state when data to be transmitted is generated in the dormant state based on the suspended mode; and an access network (AN) for receiving the slot cycle index value from the UA, adjusting a paging time, and transmitting a paging message to the UA according to the adjusted paging time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a network for providing a push-to-talk (PTT) service in a code division multiple access (CDMA)-2000 First Evolution (1×) system;

FIG. 2 is a flow chart illustrating a call procedure for a dormant state of the CDMA2000 1× system;

FIG. 3 shows a state transition operation of a conventional user agent (UA) in the CDMA2000 1× system;

FIG. 4 is a block diagram illustrating a state transition operation of a user agent (UA) in accordance with an embodiment of the present invention; and

FIG. 5 is a flow chart illustrating the state transition operation of the UA shown in FIG. 4.

It should be understood that in the drawings, like reference numbers refer to like features and structures.

### DETAILED DESCRIPTION OF THE PREFERRED EMBODIMENTS

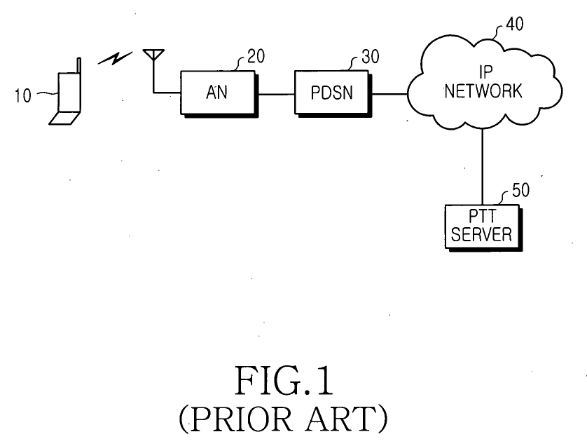

Embodiments of the present invention will now be described in detail with reference to the accompanying drawings. In the following description of the present invention, a detailed description of known functions and configurations incorporated herein will be omitted for conciseness. The following description of the present invention will be provided using a push-to-talk (PTT) service. Because the network architecture for the PTT service is substantially the same as the network architecture shown in FIG. 1, the network architecture in accordance with an embodiment of the present invention will be described with reference to FIG. 1.

Referring to FIG. 1, the PTT service network includes a user agent (UA) 10 for performing radio access according to the CDMA2000 1× standard, and a CDMA2000 1× access network (AN) 20 for performing packet communication with the UA 10. The PTT service network includes a packet data service node (PDSN) 30 for transmitting, to the AN 20, packet data using Internet protocol (IP), etc., and a PTT server 50 connected to the PDSN through an IP network 40 for providing the PTT service.

The PTT server 50 manages a PTT session, and relays a voice packet from a talker to a group of listeners.

In the wireless communication system, the UA 10 in a suspended state synchronizes with a time period of the AN 20 in a slot mode. The slot mode is one technique for reducing battery power consumption in the UA 10.

The UA 10 supports the PTT service and is equipped with a PTT button (not shown). The UA 10 operates a receiving circuit for approximately 160-240 msec (including a time for which the UA is awake) in each time period based on a slot cycle index (SCI), demodulates a paging channel signal, and determines whether or not a paging message has been received. The life of the battery provided in the UA 10 in a reception standby state is determined by a paging channel search period. Here, a slot cycle can be expressed by the following Equation 1. Where the slot index is 2, the slot cycle can be set to approximately 5.12 seconds.
Slot_Cycle (sec)=1.28×2^{Slot}^{_{—}}^{Cycle}^{_{—}}^{Index} Equation 1

The UA 10 transmits its own SCI value to the AN 20 in order to perform the slot mode function. The SCI value is included in a field value of an SCI adjustment message such as an origination, paging response, registration or state message, and is transmitted to a base station.

The formats of transmitted origination, paging response, registration and state messages are shown in the following Tables 1 to 4. As shown in the following Tables 1 to 4, an SCI value is included in a “SLOT_CYCLE_INDEX” field having the length of 3 bits.

TABLE 1

| Field | Length (bits) |
|---|---|
| MOB_TERM | 1 |
| SLOT_CYCLE_INDEX | 3 |
| MOB_P_REV | 8 |
| SCM | 8 |
| REQUEST_MODE | 3 |
| SPECIAL_SERVICE | 1 |
| SPECIAL_OPTION | 0 or 16 |
| Others | |

TABLE 2

| Field | Length (bits) |
|---|---|
| MOB_TERM | 1 |
| SLOT_CYCLE_INDEX | 3 |
| MOB_P_REV | 8 |
| SCM | 8 |
| REQUEST_MODE | 3 |
| SERVICE_OPTION | 16 |
| Others | |

TABLE 3

| Field | Length (bits) |
|---|---|
| REG_TYPE | 4 |
| SLOT_CYCLE_INDEX | 3 |
| MOB_P_REV | 8 |
| SCM | 8 |
| MOB_TERM | 1 |
| RETURN_CAUSE | 4 |
| Others | |

TABLE 4

| Field | Length (bits) |
|---|---|
| MOB_P_REV | 8 |
| MOB_MFG_CODE | 8 |
| MOB_MODEL | 8 |
| MOB_FIRM_REV | 16 |
| SCM | 8 |
| LOCAL_CTRL | 1 |
| SLOT_CYCLE_INDEX | 3 |

A cycle index typically uses a fixed large value (e.g., 2). Even though a state of the UA 10 transitions, the SCI value does not vary. As described, the PTT service transitions from an active state to the dormant state when no packet data is generated for a predetermined time, and then a traffic channel is re-activated in response to a paging request of the base station when packet data is generated. After initiating a paging operation for the PTT service, the UA 10 operates in the slot mode so that battery power consumption can be reduced in the dormant state. As the UA 10 responds to the paging request, a communication connection time becomes longer.

The following description will be given of a call processing operation in the dormant state between the UA and the PTT service network included in the CDMA2000 1× system with reference to the accompanying drawings.

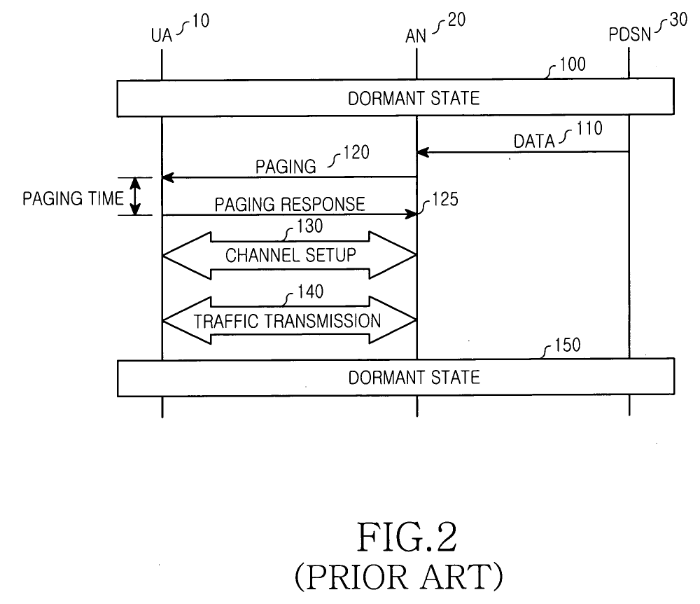

FIG. 2 is a flow chart illustrating a call procedure for a dormant state of the CDMA2000 1× system.

Referring to FIG. 2, when the UA 10 transitions from the active state to the dormant state at step 100, it sends, to the AN 20, an SCI adjustment message including an SCI value after releasing an air traffic channel and switching from an operating mode to a suspended mode. The AN 20 adjusts a paging time according to the SCI value. Subsequently, the PDSN 30 sends packet data to the AN 20 at step 110 and then the AN 20 sends a paging message to the UA 20 at step 120.

At step 125, the UA 10 sends a paging response message for a preset paging time to the AN 20 after receiving the adjusted paging message. If the paging procedure has been completed, the UA 10 performs a channel setup procedure with the AN 20 at step 130 and sets up a traffic channel with the AN 20 at step 140. Thus, the AN 20 sends the packet data received from the PDSN 30 to the UA 10. That is, the UA 10 carries out a traffic transmission operation. At this point, if the traffic transmission operation has been completed, the UA 10 releases the traffic channel to reduce battery power consumption, and performs the operation described at the above step 100 in order to transition to the dormant state at step 150.

Next, a state transition operation in the CDMA2000 1× system in accordance with an embodiment of the present invention will be described while being compared with a conventional state transition operation. First, the state transition operation of the UA will be described with reference to the accompanying drawings.

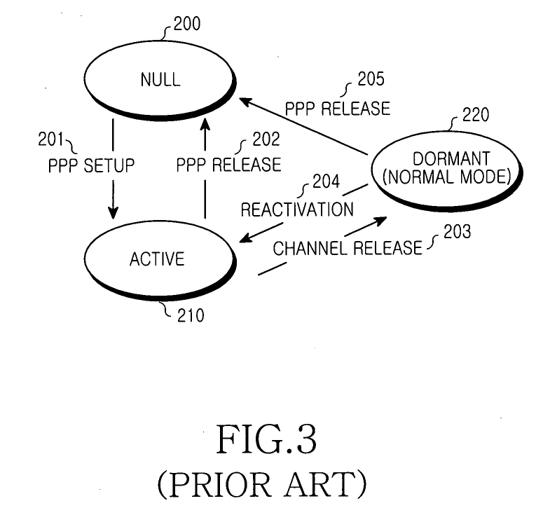

FIG. 3 shows a state transition operation of a conventional user agent (UA) in the CDMA2000 1× system.

States of the UA 10 for the conventional call setup are classified as a null state 200, an active state 210 and a dormant state 220. The null state 200 indicates a default state before a packet data service is activated.

When a service request is generated in the null state 200 at step 201, the AN 20 and the UA 10 exchange information necessary for obtaining service through a common channel and performs a point-to-point protocol (PPP) setup operation. Thus, a service connection is formed between the UA 10, the AN 20 and the PDSN 30 which is coupled to the AN 20. Subsequently, the UA 10 transitions to a control state (not shown) and exchanges a control message. Then, if a dedicated traffic channel has been set up in the control state, the UA 10 transitions to the active state 210 and exchanges packet data with the AN 20.

When no packet data is generated for a predetermined time in the active state 210, the UA 10 performs a PPP releasing operation to release a connection with the PDSN 30 at step 202. At step 203, the UA 10 releases all dedicated channels as well as the dedicated traffic channel. Subsequently, the UA 10 transitions from the active state 210 to the dormant state 220. At this point, the UA 10 sends an adjustment information message including a fixed SCI value (e.g., 2) to the AN 20. If packet data to be sent is generated when a traffic channel is initiated, the AN 20 sets a paging message in a period based on the fixed SCI value and sends the paging message to the UA 10.

Upon receiving the paging message at step 204, the UA 10 performs an operation for re-setting up a traffic channel with the AN 20. At this point, if the traffic channel has been set up, the UA 10 transitions to the active state 210, and receives the generated packet data. If packet data is no longer generated after the generated packet data is received, the UA 10 releases the channel as at the above step 203 and then transitions to the dormant state 220.

At step 205, the UA 10 in the dormant state releases a PPP session when a PPP session timer times out and then transitions to the null state 200.

On the other hand, in the PTT service, a setup operation must be rapidly performed so that the user can hear a signal sound indicating that he or she is allowed to start talking by pressing a push button. For example, in the CDMA2000 1× system operating as shown in FIG. 2, a time between approximately 2 and 3 seconds is taken when a traffic channel is set up in the dormant state, and a paging time between approximately 1 and 2 seconds is taken when first signalling is transferred to an opposite party.

Referring to the above-described procedure, the dormant state of the UA in the course of the PTT service is divided into the suspended mode and the normal mode, such that an operation for rapidly re-activating a traffic channel is performed. In the dormant state based on the suspended mode, a slot mode operation is performed according to a value smaller than the fixed SCI value in the normal mode when the traffic channel is initiated. The smaller SCI value is used to reduce a paging time.

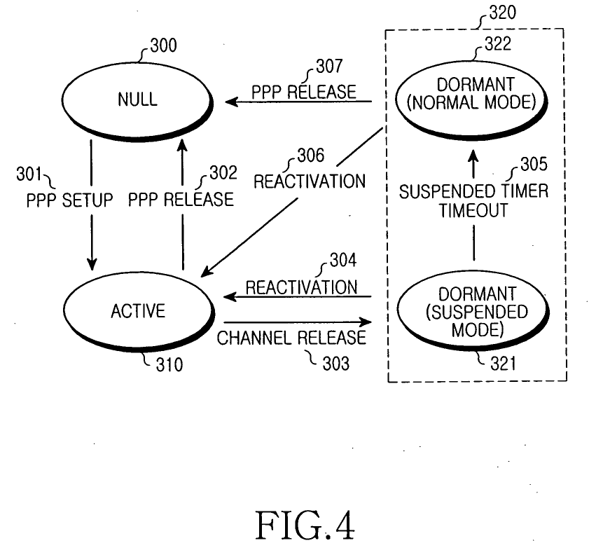

FIG. 4 is a block diagram illustrating a state transition operation of the UA in accordance with an embodiment of the present invention.

Referring to FIG. 4, states of the UA 10 for fast call setup are classified as a null state 300, an active state 310 and a dormant state 320. Here, the null state 300 indicates a default state before a packet data service is activated. The dormant state 320 is divided into a suspended mode 321 and a normal mode 322.

When a service request is generated in the null state 300, the AN 20 and the UA 10 exchange information necessary to obtain for service through a common channel, perform a point-to-point protocol (PPP) setup operation, transitions to a control state (not shown), and exchange a control message at step 301. Then, if a dedicated traffic channel has been set up in the control state, the UA 10 transitions to the active state 310 and exchanges packet data with the AN 20.

If no packet data to be sent from the PTT server 50 is generated for a predetermined time in the active state 310, the UA 10 releases the PPP connection and releases the traffic channel as well as the dedicated channel at step 302.

At step 303, the UA 10 transitions to the dormant state based on the suspended mode 321. At this point, a suspended timer is started, and the fixed SCI value (e.g., 2) is changed to a smaller SCI value (e.g., 0). Furthermore, the UA 10 sends an SCI adjustment message including the changed SCI value to the AN 20. Thus, the AN 20 adjusts a paging time according to the changed SCI value. Subsequently, when packet data to be sent from the PTT server 50 is generated, the AN 20 receives the generated packet data through the PDSN 30 and transmits a paging message to the UA 10 according to the adjusted time so that the received packet data can be sent to the UA 10. Consequently, the UA 10 in the dormant state can reduce the paging time.

Upon receiving the paging message from the AN 20, the UA 10 performs an operation for traffic channel setup at step 304. Subsequently, the UA 10 sends a paging response message to the AN 20, stops the suspended timer, transitions from the dormant state based on the suspended mode 321 to the active state 310, sets up a traffic channel, and receives packet data from the AN 20.

Subsequently, if packet data is no longer generated, the UA 10 releases the traffic channel as at step 303, transitions to the dormant state based on the suspended mode 321, and re-starts the suspended timer.

When the suspended timer times out in the dormant state based on the suspended mode 321, the UA 10 transitions to the dormant state based on the normal mode 322 at step 305. At this point, the UA 10 increments the changed SCI value (e.g., 0) to a predetermined value (e.g., 2). Here, the suspended timer is used to prevent battery power consumption from increasing when the suspended mode is maintained for a long time.

At step 306, the UA 10 receiving the paging message from the AN 20 in the dormant state based on the suspended mode 321 transitions to the active state 310 in order to set up the traffic channel and receives the generated packet data. Subsequently, if the traffic data has been completely transmitted, the UA 10 transitions to the dormant state based on the normal mode 322.

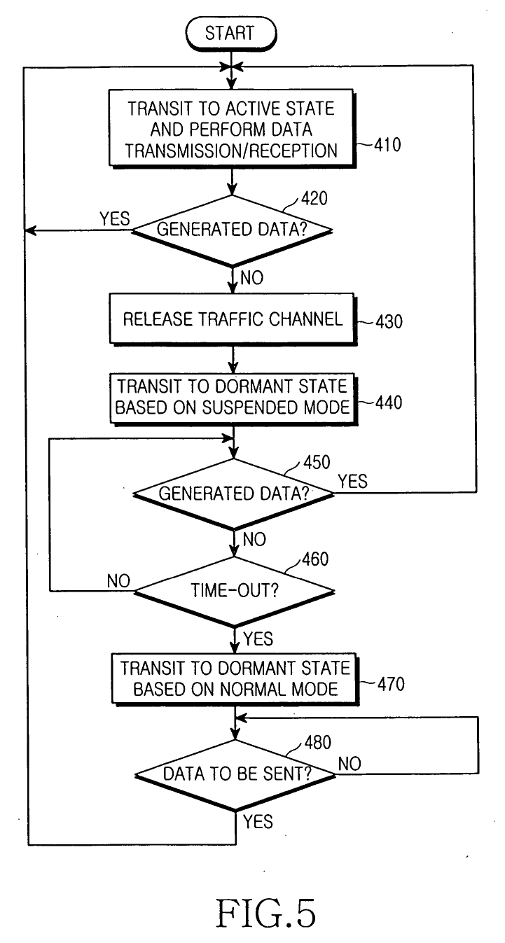

When the PPP session timer times out in the dormant state based on the normal mode 322, the UA 10 releases the PPP session and transitions to the null state 300 at step 307. The state transition operation will be briefly described with reference to the flow chart shown in FIG. 5.

Referring to FIG. 5, the UA 10 performs a PPP setup operation with the AN 20, transitions to the active state, and transmits and receives packet data generated from the PTT server 50 through the PDSN 30 and the AN 20 at step 410. Subsequently, the UA 10 makes a determination as to whether or not generated packet data is present at step 420. If generated packet data is present, the UA 10 returns to step 410. On the other hand, if no generated packet data is present, the UA 10 proceeds to step 430.

The UA 10 releases a set-up traffic channel at the above step 430, and transitions from the active state to the dormant state based on the suspended mode at step 440. Subsequently, the UA 10 determines, at step 450, whether or not packet data has been generated. If packet data has been generated, the UA 10 performs the above step 410. On the other hand, if packet data has not been generated, the UA 10 determines, at step 460, whether or not the suspended timer has timed out. If the suspended timer has not timed out as a result of the determination, the UA 10 returns to step 450. On the other hand, if the suspended timer has timed out, the UA 10 proceeds to step 470.

The UA 10 transitions from the dormant state based on the suspended mode to the dormant state based on the normal mode at step 470, and then determines, at step 480, whether or not packet data to be sent has been generated. At this point, if packet data to be sent has been generated, the UA 10 returns to step 410, transitions from the dormant state based on the normal mode to the active state, and transmits and receives the packet data. On the other hand, if no transmission packet data has been generated, the UA 10 repeats step 480 and determines whether or not packet data to be sent has been generated.

In accordance with the present invention, as apparent from the above description, a dormant state in a push-to-talk (PTT) service is divided into a suspended mode and a normal mode. As a slot cycle index (SCI) value is changed to a smaller value in the suspended mode, a paging time can be reduced and hence a traffic channel can be rapidly re-activated from in the dormant state.

Although the embodiments of the present invention have been disclosed for illustrative purposes, those skilled in the art will appreciate that various modifications, additions and substitutions are possible, without departing from the scope of the invention. In detail, an operation for performing fast call setup in a push-to-talk (PTT) service has been described in the embodiments of the present invention. Moreover, it should be noted that the present invention can be applied to all types of services requiring fast call setup. Therefore, the present invention is not limited to the above-described embodiments, but the present invention is defined by the claims which follow, along with their full scope of equivalents.

1. A method for rapidly processing a call when one of a plurality of user agents (UAs) in a dormant state makes a traffic transmission request in a wireless telecommunication system, the wireless telecommunication system including an access network (AN) for simultaneously performing group communication with at least two UAs, the method comprising the steps of:
releasing the traffic channel and transitioning to the dormant state based on a suspended mode when no data is generated for a predetermined time after a traffic channel has been set up in an active state;
setting a slot cycle index value to a first slot cycle index value for a slot mode operation in the dormant state based on the suspended mode, and notifying the AN of the first slot cycle index value;
receiving a paging message according to a paging time adjusted by the AN using the first slot cycle index value; and
receiving the paging message and setting up the traffic channel after transitioning to the active state when data to be transmitted is generated in the dormant state based on the suspended mode.

2. The method according to claim 1, wherein the first slot cycle index value is smaller than a fixed slot cycle index value.

3. The method according to claim 1, further comprising the steps of:
transitioning to the dormant state based on a normal mode when no data is generated for a predetermined time in the dormant state based on the suspended mode;
setting a slot cycle index value to a second slot cycle index value for the slot mode operation in the dormant state based on the normal mode, and notifying the AN of the second slot cycle index value; and
receiving the paging message, and setting up the traffic channel after transitioning to the active state when data to be transmitted is generated in the dormant state based on the normal mode.

4. The method according to claim 3, wherein the second slot cycle index value comprises a value set by increasing the first slot cycle index value.

5. The method according to claim 1, wherein the slot cycle index value is included in at least one of an origination message, a response message associated with the paging message, a registration message and a state message.

6. The method according to claim 5, wherein the AN is notified of the slot cycle index value included in the message.

7. The method according to claim 1, wherein each of the plurality of UAs includes a push to talk button.

8. A system for rapidly processing a call when one of a plurality of user agents (UAs) in a dormant state makes a traffic transmission request in a wireless telecommunication system, the wireless telecommunication system including an access network (AN) for simultaneously performing group communication with at least two UAs, the system comprising:
the UA for releasing a traffic channel when no data is generated for a predetermined time after the traffic channel has been set up in an active state, transitioning to the dormant state based on a suspended mode, setting a slot cycle index value to a first slot cycle index value for a slot mode operation in the dormant state based on the suspended mode, and re-activating the traffic channel after transitioning to the active state when data to be transmitted is generated in the dormant state based on the suspended mode; and
an access network (AN) for receiving the slot cycle index value from the UA, adjusting a paging time, and transmitting a paging message to the UA according to the adjusted paging time.

9. The system according to claim 8, further comprising:
a packet data service node (PDSN) for transmitting data to the UA through the AN when the traffic channel is set up.

10. The system according to claim 8, further comprising:
a push-to-talk (PTT) server for managing sessions for the group communication and relaying voice and packet data to be transmitted to the UAs capable of performing the group communication.

11. The system according to claim 8, wherein the first slot cycle index value is smaller than a fixed slot cycle index value.

12. The system according to claim 8, wherein the UA transitions to the dormant state based on a normal mode when no data is generated for a predetermined time in the dormant state based on the suspended mode, sets a slot cycle index value to a second slot cycle index value for the slot mode operation in the dormant state based on the normal mode, notifies the AN of the second slot cycle index value, receives the paging message, and sets up the traffic channel after transitioning to the active state when data to be transmitted is generated in the dormant state based on the normal mode.

13. The system according to claim 12, wherein the second slot cycle index value is a value set by increasing the first slot cycle index value.

14. The system according to claim 8, wherein the slot cycle index value is included in at least one of an origination message, a response message associated with the paging message, a registration message and a state message.

15. The system according to claim 8, wherein the AN is notified of the slot cycle index value included in the message.

16. The system according to claim 8, wherein each of the plurality of UAs include a push to talk button.
